(19) United States
(12) Patent Application Publication
(10) Pub. No.: US 2011/0266785 A1
(43) Pub. Date: Nov. 3, 2011

(54) MOTOR VEHICLE AND METHOD OF MANUFACTURE THEREFOR

(75) Inventor: Udo MILDNER, Limburg (DE)

(73) Assignee: GM GLOBAL TECHNOLOGY OPERATIONS LLC, Detroit, MI (US)

(21) Appl. No.: 13/095,589

(22) Filed: Apr. 27, 2011

(30) Foreign Application Priority Data
Apr. 28, 2010 (DE) 102010018482.9

(51) Int. Cl. B62D 21/12; B23P 11/00

(52) U.S. Cl. 280/785; 29/525.01; 29/525.05

(57) ABSTRACT

In a motor vehicle includes, but is not limited to a chassis module, a front module, and a body, front module, body, and chassis module, At least one first and one second set of cooperating fastenings are provided for fastening the front module on the chassis module and/or the body. The cooperating fastenings of the first set define an axis about which the front module can be pivoted relative to the chassis module into a stop position in which it is held by the fastening means of the second set.

### CROSS-REFERENCE TO RELATED APPLICATION

This application claims priority to German Patent Application No. 102010018482.9, filed Apr. 28, 2010, which is incorporated herein by reference in its entirety.

### TECHNICAL FIELD

The technical field relates to a motor vehicle composed of a plurality of modules, including at least one chassis module, a front module, and a body, and a method for the manufacture thereof.

### BACKGROUND

An assembly station for carrying out the assembly method is known from DE 10 2007 017 167 A1. This prior-published application comprises an assembly plate on which the front module and the chassis module are placed as well as transporting tools for transporting toward and exact placement of the components to be assembled. After lowering the body onto the chassis module, the front module is pivoted toward the chassis module and the body about an axis defined by a supporting column of the assembly plate and is fastened. This method certainly enables a rapid and simple assembly of the motor vehicle but is to some extent complex in practical implementation since assembly plates adapted in each case to a type of vehicle to be assembled are required in order to place front and chassis module with respect to one another so that through pivoting, the front module enters precisely into the position in which it can be fastened on the body and/or chassis module. In addition, the large number of working steps which need to be executed while the vehicle is located on the assembly plate (lowering the body and connecting to the chassis module, pivoting the front module and fastening the front module), necessitates a long dwell time of the vehicle on the assembly plate. In order to prevent this phase from forming a bottleneck during series production, a large number of assembly stations need to be provided which again increases the costs.

Therefore, it is at least one object to provide a motor vehicle, which can be mounted in the manner known from DE 10 2007 017 167 A1 by pivoting a front module toward chassis module and body, but for the mounting whereof a simplified assembly plate is sufficient and in which the dwell time on the assembly plate can be shortened, or to further develop the assembly method known from DE 10 2007 017 167 A1 such that the implementation costs are reduced.

### SUMMARY

The at least one object is achieved on the one hand by a method for assembling a motor vehicle comprising the steps fitting into one another first fastening means of a chassis module and a front module of the motor vehicle in a preliminary position, bringing together the modules with a body as far as a stop position of the chassis module on the body, then pivoting the front module about an axis defined by the first fastening means, which have been fitted into one another, into a final position, and fastening the front module on the chassis module or the body by means of second fastening means.

The object is achieved on the other hand whereby in a motor vehicle comprising a chassis module, a front module, and a body wherein front module, body, and chassis module comprise at least one first and one second set of cooperating fastening means for fastening the front module on the chassis module and/or the body, the cooperating fastening means of the first set define an axis about which the front module can be pivoted relative to the chassis module into a stop position in which it is held by the fastening means of the second set.

Since the first set of fastening means defines the pivot axis of the front module, the supporting column of the assembly plate conventionally provided for this purpose is superfluous. The assembly plate is therefore on the one hand simpler and cheaper and on the other hand, it is also less specific to vehicle type so that the same assembly station can be used for fabricating different types of vehicle without retrofitting or with relatively little retrofitting effort. The fastening means of the first set can expediently comprise at least one fork and a hinge bolt embraced by the fork. The fork can be part of the front module; then the hinge bolt is part of the body or, preferably, of the chassis module. Conversely, however, the hinge bolt can be part of the front module; then the fork pertains to the body or to the chassis module.

A lead-in chamfer formed on the fork facilitates the placement of the hinge bolt in the fork. The fork is expediently oriented so that it and the hinge bolt can be fitted into one another by a lowering movement of the front module. That is, if the fork is part of the front module, its opening points downward whereas in the case of a fork pertaining to the chassis module or to the body, the opening is directed upward.

The chassis module can comprise a supporting structure such as an engine frame, to which a fastening means of the first set, that is in particular the form or the hinge bolt, is firmly connected. If at least one part of the supporting structure is fabricated by a molding method such as die casting, the fastening means of the first set is expediently molded in one part with this part.

A highly stiff piece of the supporting structure which can be implemented using simple molding tools can comprise a base plate and reinforcing ribs projecting from the base plate in a demolding direction. In such a case, the fastening means of the first set is preferably a hinge bolt which is held by walls aligned in the demolding direction. To save weight, the supporting structure can be composed of extruded supports and at least one connecting piece that connect at least two of the supports. This connecting piece can expediently be the aforementioned part fabricated by a molding method.

The second set of cooperating fastening means preferably comprises an elastically deflectable locking hook and an edge on which the locking hook acts in the stop position. Thus, after fitting the fastening means of the first set into one another, a simple pivoting of the front module into the stop position is sufficient to at least temporarily fasten the front module. An assembly station at which this fabrication step has taken place can now be made free in order to assemble front module, chassis module, and body of the next vehicle there, while further assembly steps such as a definitive fastening of the front module of the vehicle just assembled can be carried out at another location. If the dwell time of the individual vehicle at the assembly station is shortened in this way, the number of assembly stations required for a given production speed is reduced, which allows significant cost savings during manufacture.

A fastening means of the second set is preferably disposed on the body, vertically spaced apart from the first set of fastening means connecting the front module, preferably to the chassis module. If a longitudinal member of the body is terminated at its front end by a flange in a manner known per se, a fastening means of the second set can expediently be disposed on the flange.

The front module preferably comprises at least one radiator assembly and a radiator frame extending around the radiator assembly. To save weight, the radiator frame can expediently be formed at least in part, in hybrid technology, by a plastic-sheathed sheet. Furthermore, a bumper cross member can be part of the front module.

In order to make the assembly of body and front module, in particular a vertical movement of body and front module toward one another, simple and reliable, the radiator frame can have a width which decreases from bottom to top in order to facilitate the insertion thereof into the body, in particular between the longitudinal members thereof.

### BRIEF DESCRIPTION OF THE DRAWINGS

The present invention will hereinafter be described in conjunction with the following drawing figures, wherein like numerals denote like elements, and:

FIG. 1 shows a first stage of the assembly of a vehicle according to an embodiment;

FIG. 2 shows a second assembly stage;

FIG. 3 shows a third assembly stage;

FIG. 4 shows a perspective view of an engine frame forming a part of the front module of the vehicle;

FIG. 5 shows an enlarged detail of the engine frame from FIG. 4;

FIG. 6 shows a perspective view of the front module of the vehicle;

FIG. 7 shows an enlarged detail of the front module from FIG. 6;

FIG. 8 shows the engine frame as well as parts of the front module in the assembled state;

FIG. 9 shows an enlarged detail of the front module from FIG. 8;

FIG. 10 shows the vehicle components shown in FIG. 8, joined to longitudinal members of the body;

FIG. 11 shows an enlarged detail from FIG. 10;

FIG. 12 shows a schematic section in the vehicle longitudinal direction through the structure of FIG. 10;

FIG. 13 shows an enlarged detail from FIG. 12;

FIG. 14 shows a perspective view of a front end structure forming a part of the body according to a second embodiment of the invention;

FIG. 15 shows an enlarged detail of the front end structure from FIG. 14;

FIG. 16 shows a radiator frame according to the second embodiment; and

FIG. 17 shows a front module, an engine frame as well as parts of the front end structure in the assembly step of FIG. 2 according to the second embodiment.

### DETAILED DESCRIPTION

The following detailed description is merely exemplary in nature and is not intended to limit application and uses. Furthermore, there is no intention to be bound by any theory presented in the preceding background or summary or the following detailed description.

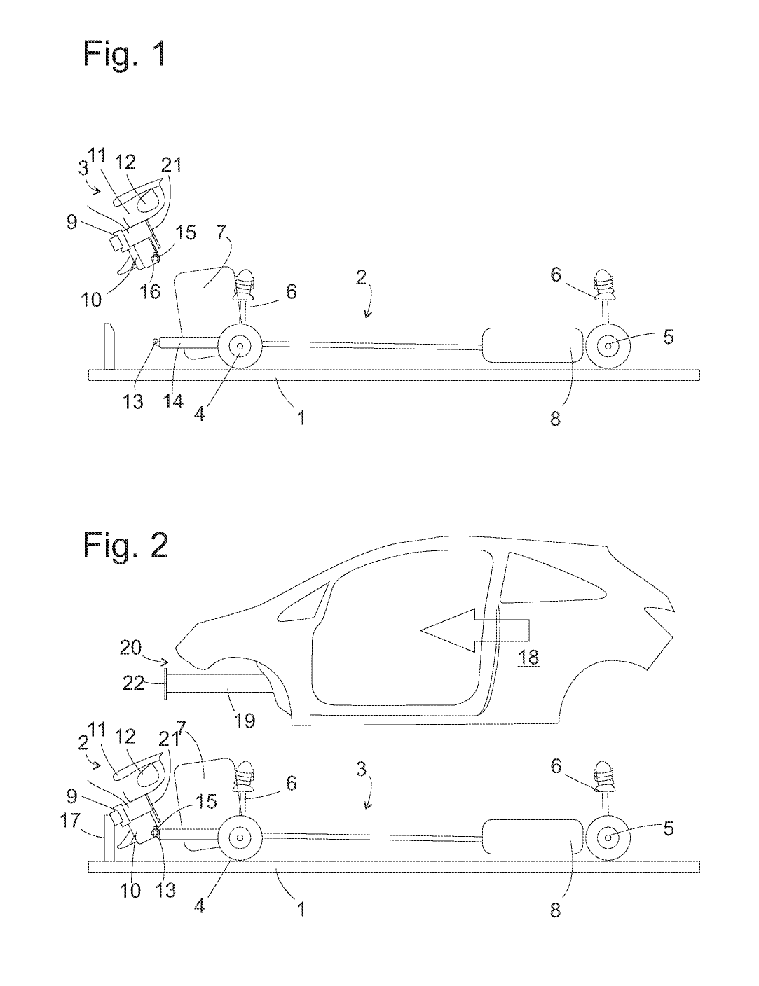

FIG. 1 shows in a side view a chassis module 2 of a motor vehicle placed on a liftable assembly plate 1. The chassis module 2 comprises a chassis comprising front and rear axle 4, 5 each having two suspension struts 6, an engine frame 14, an engine 7 anchored in the engine frame 14, a tank 8, as well as other components omitted in the schematic diagram. At two front corners of the engine frame 14, pairs of supports project in each case, said supports holding between them respectively one horizontal hinge bolt 13.

A front module 3 to be mounted on the chassis module 2 is shown in FIG. 1 above the hinge bolt 13. A bumper support 9, a radiator assembly 10, and a radiator frame 11 are connected in the front module 3. Holders 12 for headlamps can be integrated in the radiator frame 11. An upper strut of the radiator frame 11 can additionally serve as a holder of a hood lock for a hood (not yet mounted and therefore not shown in the figure) of the vehicle. Two downwardly open forks 15 project from the radiator frame 11 on opposite sides. In order to facilitate a snapping of the forks 15 onto the hinge bolts 13, when the front module 3 is lowered from the position shown in FIG. 1, the forks 15 are each provided with lead-in chamfers 16 at the free ends of their tines.

FIG. 2 shows a later stage of the assembly in which the front module 3 is lowered onto the chassis module 2 and the forks 15 are locked embracingly onto the hinge bolts 13. In this stage, the front module 3 can be pivoted relative to the chassis module 2 about a horizontal axis which runs perpendicular to the plane of the drawing through the two hinge bolts 13. In the orientation shown in FIG. 2 the front module 3 can be held with the aid of a supporting column 17 emanating from the assembly plate 1, against which the front side of the bumper support 9 or another suitable loadable surface of the front module 3 abuts. Alternatively it would be feasible to temporarily hold the front module 3 in the orientation shown with the aid of the same transport apparatus that has been used to convey the front module 3 toward the assembly plate 1 and for lowering onto the chassis module 2.

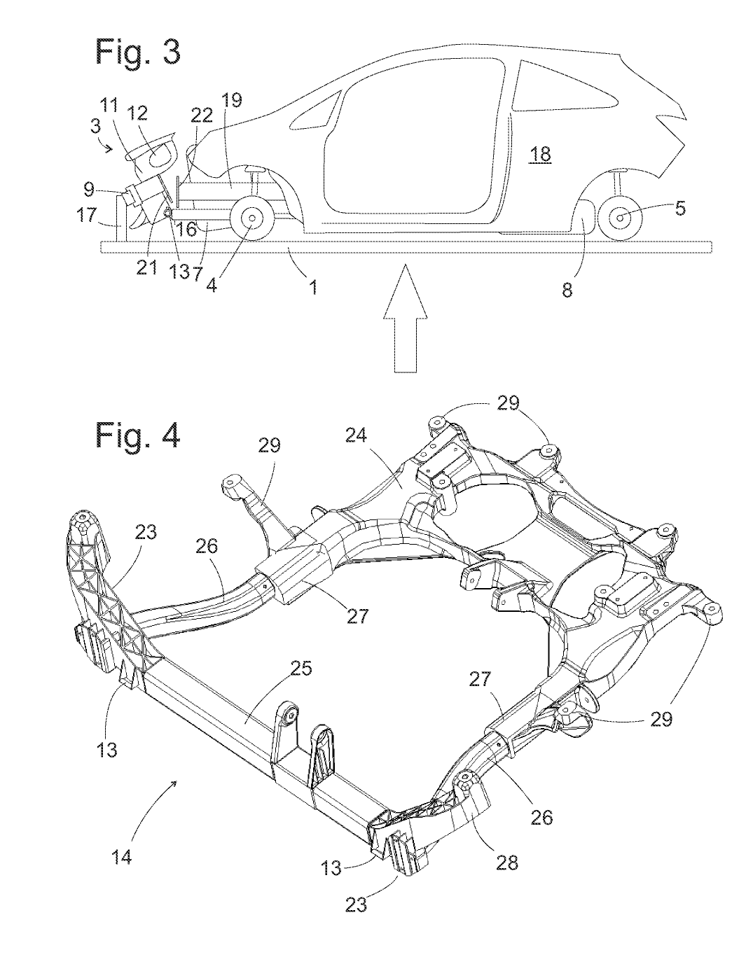

In the next step, a vehicle body 18, as indicated by an arrow, is brought into the position shown in FIG. 2 above the assembly plate 1. The body 18 has a rigid frame with two longitudinal members 19, whose front ends projects into an engine compartment 20 on the front side of the body 18. The body 18 is placed above the assembly plate 1 so that by raising the assembly plate 1, the engine 7 moves between the two longitudinal members 19 and the suspension struts 6 dip into corresponding receptacles of the body 18, which are not shown. This stage is shown in FIG. 3.

In the next assembly step the front module 3 is pivoted about the axis defined by the hinge bolts 13 in the clockwise direction onto the body 18 until two flanges 21 on the rear side of the front module 3 abut against flanges 22 which terminate the longitudinal members 19 toward the front. In this position, parts of the radiator frame 11, in particular the headlamp holders 12, are located vertically above the longitudinal members 19, which is the reason why the body 18 must be placed on the chassis module 2 before pivoting the front module 3.

Since the freedom of movement of the front module 3 in relation to the chassis module 2 is already restricted to a single degree of rotational freedom due to the engagement of the forks 15 and hinge bolts 13, a few fastening means attached expediently to the two flanges 21, 22 are sufficient to fasten the modules 2, 3 permanently onto one another.

FIG. 4 shows in a perspective view the engine frame 14 obliquely from the front and from above. The engine frame (assembly plate 1) could be a one-piece casting, for example, die-cast aluminum. FIG. 4 shows a preferred further development, as a result of which the engine frame 14 is composed of a plurality of components, i.e., two front corner pieces 23 made of die-cast aluminum, a rear frame part 24 also made of die-cast aluminum, as well as a front cross strut 25 and two longitudinal struts 26, which are fabricated as extruded profiles, preferably also made of aluminum. The rear frame part 24 has two frontwardly projecting hollow arms 27, into which the longitudinal struts 26 are inserted positively. The corner pieces 23 have pins, not visible in the figure, which are inserted into cavities of the struts 25 or 26. Horns 28 projecting obliquely to the side and upward from the corner pieces 23 as well as projections 29 of the rear frame part 24 are used for fastening the engine frame 14 on the longitudinal members 19 of the body 18.

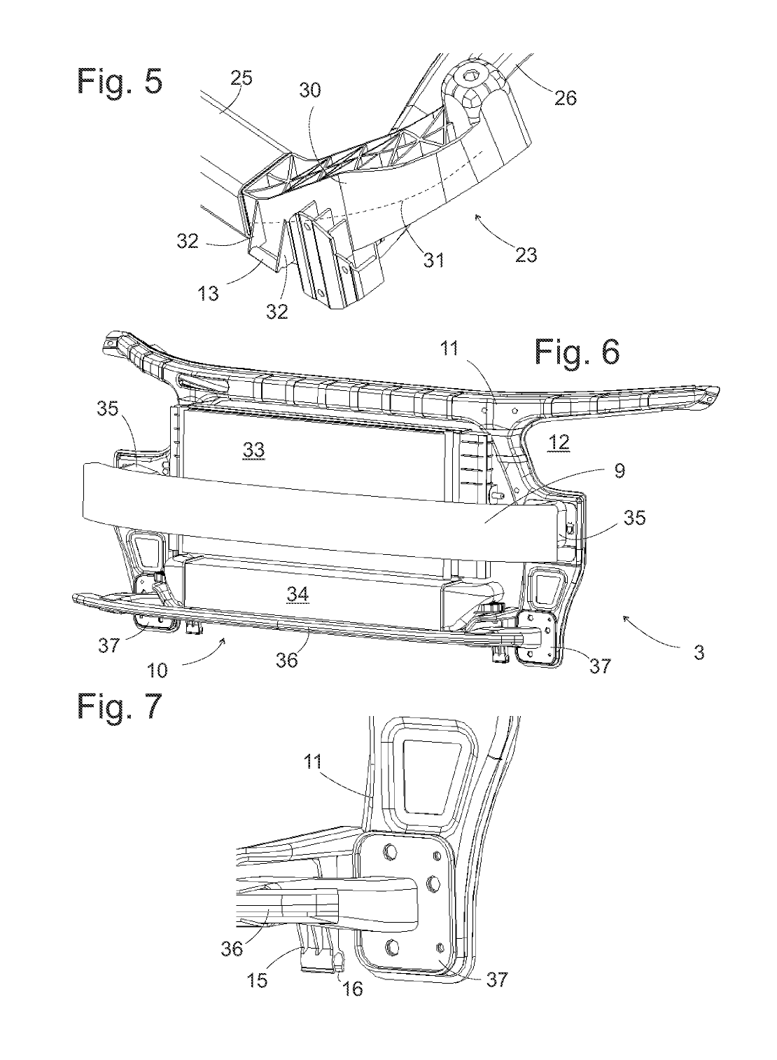

As is particularly clear from the enlarged view of a corner piece 23 in FIG. 5, the corner pieces 23 have a chassis-like structure comprising a base plate and intersecting reinforcing ribs 30 which protrude vertically upward and downward from this base plate. Since the base plate in the view in FIG. 5 is completely concealed behind one of the frontmost of the reinforcing ribs 30, its profile in FIG. 5 is indicated by a dashed line 31. Two triangular supporting plates 32 project from the frontmost reinforcing rib 30, holding one of the hinge bolts 13 between them. Since the supporting plates 32 like the reinforcing ribs 30 are vertically oriented, the base plate 31, the reinforcing ribs 30, the supporting plates 32, and the hinge bolt 13 can be fabricated in one piece using a simple forming tool, of which the two mold halves can be moved away from one another vertically, parallel to the reinforcing ribs 30 and supporting plates 32 during demolding of the finished corner piece.

FIG. 6 shows a perspective view of the front module 3. The radiator frame 11 is fabricated in one piece in hybrid technology by overmolding with plastic a thin-walled sheet deep-drawn substantially in the form of the finished radiator frame, for reinforcement. The radiator assembly 10 received in a central opening of the radiator frame 11 here comprises an engine cooler 33 and an air-conditioning or compressor cooler 34. The bumper support 9 is connected to lateral struts of the radiator frame 11 via deformation elements 35, also designated as crashboxes. A bumper reinforcing bracket 36 extends horizontally below the bumper support 9 and is fastened to the radiator frame 11 by means of two large-area flanges 37.

FIG. 7 shows the right lower corner of the front module 3 in an enlarged view. The downwardly open fork 15 can be fastened directly on the radiator frame 11, on the reinforcing bracket 36, or on the flange 37.

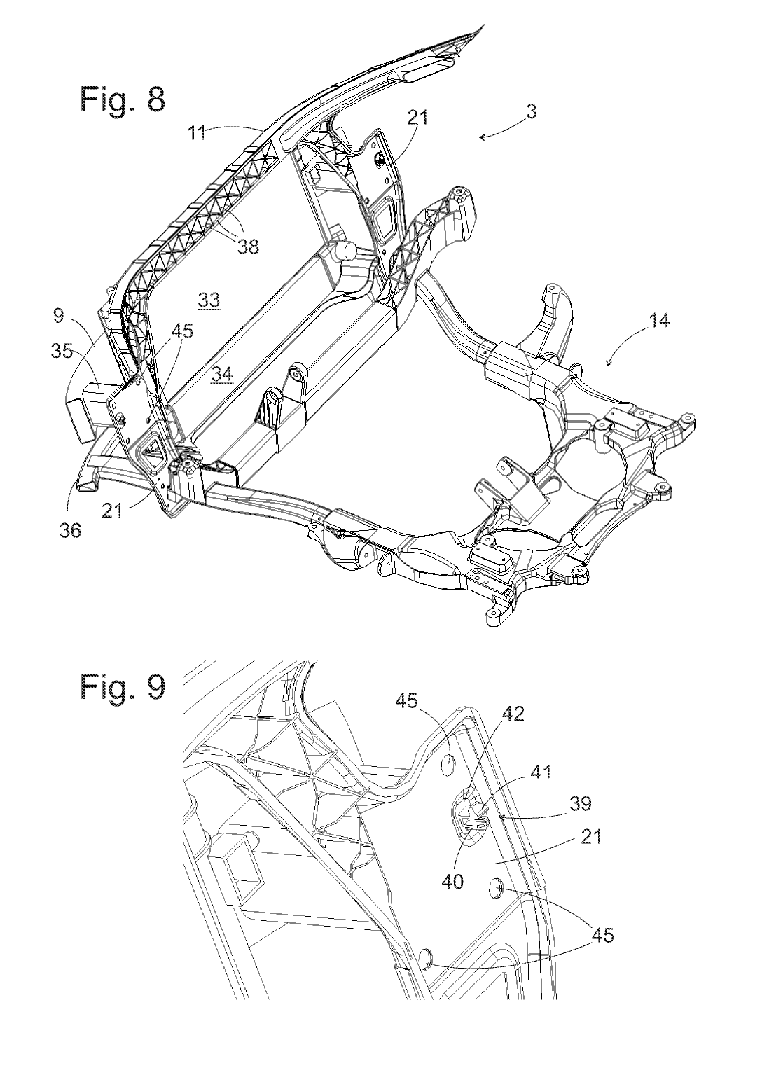

FIG. 8 shows the engine frame 14 of the chassis module 2 and the front module 3 in the assembled state. Due to the deep drawing, the inner sheet of the radiator frame has a curved cross-section in large parts, and the resulting hollow rear side of the radiator frame 11 is reinforced by a network of ribs 38, which form a frame extending around the central opening of the radiator frame 11. The flanges 21 supporting the bumper support 9 and the reinforcing bracket 36 project from these rib-reinforced regions of the radiator frame 11 in the lateral direction.

FIG. 9 shows the rear side of one of the flanges 21 at the height of the bumper support 9. A centering element 39 made of elastic plastic comprises a base plate, which is fastened on the front side of the flange 21 between this and the deformation element 35 as well as a pointed guide pin 40 and a locking hook 41, which project backward through an opening 42 formed in the flange 21.

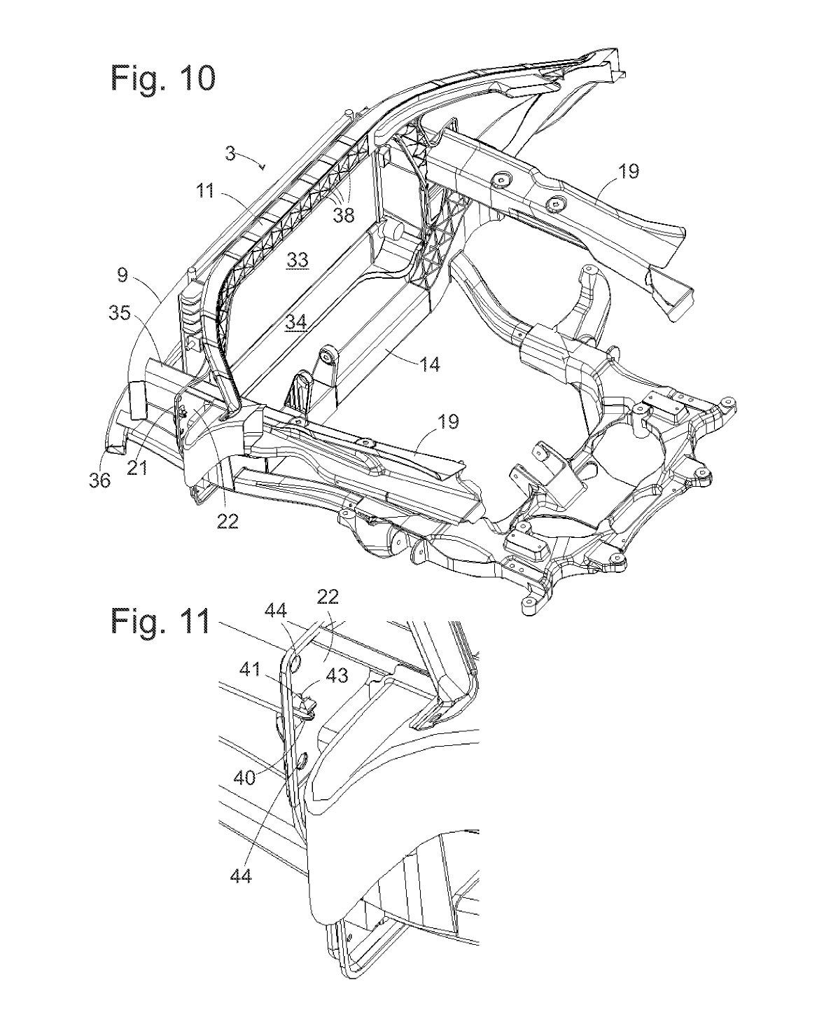

FIG. 10 shows the engine frame 14, part of the longitudinal member 19, and the front module 3 after pivoting the front module 3 into its final position. The flanges 21 of the radiator frame 11 abut against the flanges 22 which terminate the longitudinal members 19 toward the front. As can be seen in the enlarged view in FIG. 11, the guide pin 40 and the locking hook 41 of the centering element 39 have passed through an opening 43 of the flange 22. The locking hook 41 acts on the rear side of the flange 22 and thus secures the front module 3 in the position shown. In this position holes 44 of the flange 22 are aligned with holes 45 (see, for example, FIG. 6, 9) in the flange 21 of the radiator frame 11 so that the front module 3 can be permanently fastened to the longitudinal members 19 with the aid of screws inserted in the holes 44, 45. These screws can be inserted after the vehicle has already left the assembly station so that this is already available again after a short time for assembly of the next vehicle.

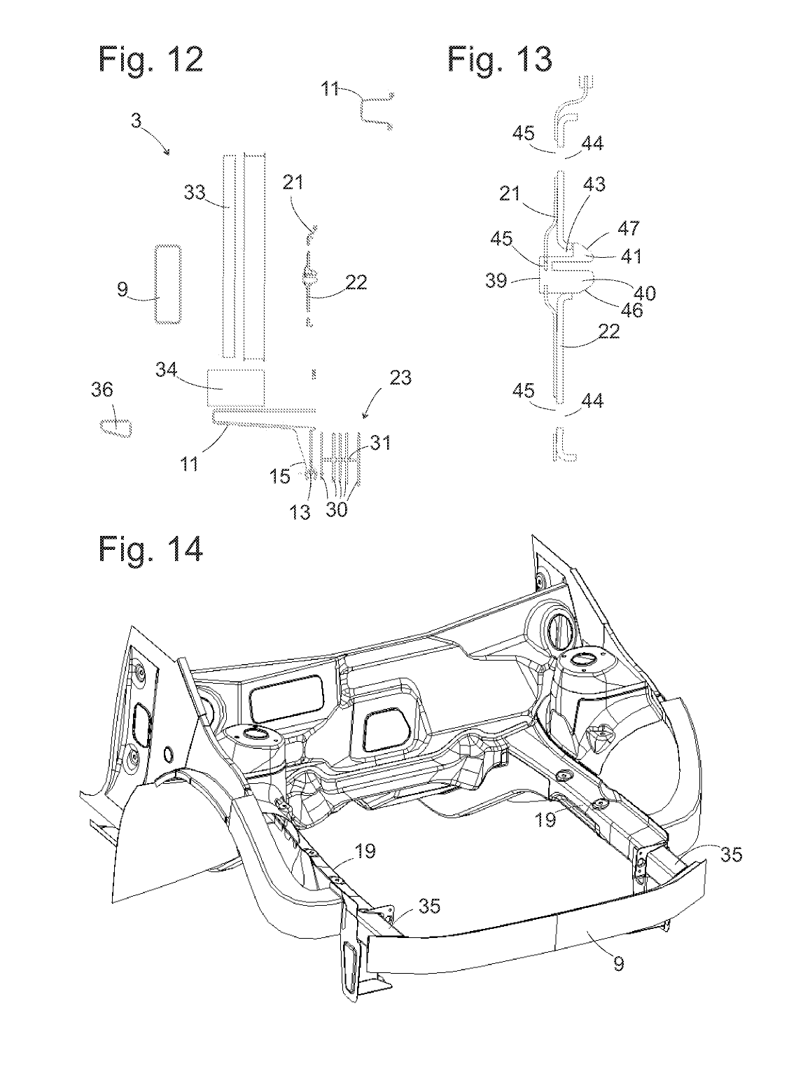

FIG. 12 shows a schematic vertical section through the front module 3, one of the corner pieces 23 of the engine frame 14 as well as the flanges 21, 22 locked onto one another. The structure of the corner piece 23 with the substantially horizontal base plate 31 and a plurality of vertical reinforcing ribs 30 intersecting the base plate 31 can be clearly identified in FIG. 12 just the same as the curved cross-section of the horizontal struts of the radiator frame 11, which is open at the back and reinforced by the ribs 38. The contacting flanges 21, 22 are shown enlarged in FIG. 13. The centering element 39 is locked vertically in an opening 45 of the flange 21 while maintaining clearance in the vehicle transverse direction, and aligns automatically when, upon pivoting of the front module 3, oblique surfaces 46, 47 of the guide pin 40 and the locking hook 41 impinge upon the edges of the opening 43. Despite possible dimensional tolerances, a rapid and secure locking of the locking hook 41 at the edge of the opening 43 is thus ensured.

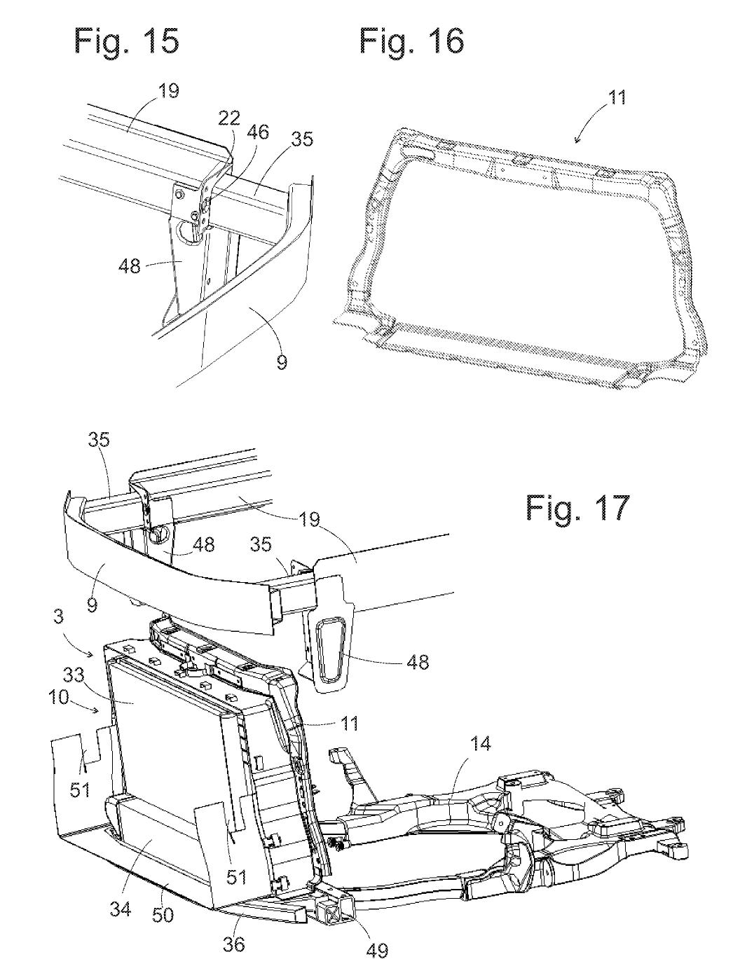

FIG. 14 shows a perspective view of the front region of a body 18 according to a second embodiment of the invention. As a result of this embodiment, a bumper support 9 is mounted by means of deformation elements 35 at the front ends of longitudinal members 19 before the body 18 is joined to front and chassis modules 3, 2. FIG. 15 shows an enlarged view of the connection between one of the longitudinal members 19 and one of the deformation elements 35. An opening 43 for receiving a locking hook of the front module 03 (not shown in FIGS. 14, 15) can be seen in an edge zone of a flange 22 disposed between longitudinal members 19 and deformation element 35, which zone projects toward the interior of the body. A support 48 extending downward from the end of the longitudinal member 19 forms a stop for the placement of the body on the chassis module.

FIG. 17 shows the engine frame 14 of the chassis module 2 of the second embodiment together with a front module 3 placed thereon. On the underside of its radiator frame 11, the front module 3 has forks, not visible in FIG. 17, which, as described with reference to FIG. 4 to FIG. 7, embrace hinge bolts projecting over a front transverse strut 49 of the engine frame. In this embodiment, a bumper reinforcing bracket 36 is mounted on the transverse strut 49 of the engine frame 14 and supports an air baffle 50 projecting from the radiator assembly 10 held in the radiator frame 11. The front module 3 is thereby held stably in the position shown in FIG. 17 without requiring the supporting column 17 on the assembly plate 1 for this. The vehicle type specificity of the assembly station can thus be further reduced. Two cutouts 51 open toward the top are formed on lateral flanks of the air baffle 50. These are provided to receive the bumper support 9 when the body 18 is lowered onto the chassis module 2.

The radiator frame 11 shown in FIG. 16 in a front view approximately has the shape of a trapezium which tapers upward. This shape facilitates the joining of chassis and front module 2 or 3 to the body 18.

While at least one exemplary embodiment has been presented in the foregoing summary and detailed description, it should be appreciated that a vast number of variations exist. It should also be appreciated that the exemplary embodiment or exemplary embodiments are only examples, and are not intended to limit the scope, applicability, or configuration in any way. Rather, the foregoing summary and detailed description will provide those skilled in the art with a convenient road map for implementing an exemplary embodiment, it being understood that various changes may be made in the function and arrangement of elements described in an exemplary embodiment without departing from the scope as set forth in the appended claims and their legal equivalents.

What is claimed is:

1. A motor vehicle, comprising:
a chassis module;
a front module; and
a first set of fastenings and a second set of fastenings configured to fasten the front module on the chassis module,
wherein the first set of fastenings define an axis about which the front module can be pivoted relative to the chassis module into a stop position held by the second set of fastenings.

2. The motor vehicle according to claim 1, wherein the first set of fastenings comprises:
a fork; and
a hinge bolt embraced by the fork.

3. The motor vehicle according to claim 2, wherein a lead-in chamfer formed on the fork.

4. The motor vehicle according to claim 2, wherein the hinge bolt and the fork are fitted by a lowering movement of the front module relative to the chassis module.

5. The motor vehicle according to claim 4, wherein the chassis module comprises a supporting structure having a part that is partially fabricated with a molding method and the first set of fastenings is molded in one part with the part of the supporting structure.

6. The motor vehicle according to claim 5, wherein the part of the supporting structure comprises:
a base plate; and
a plurality of reinforcing ribs projecting from the base plate in a demolding direction,
wherein the hinge bolt is held by walls aligned in the demolding direction.

7. The motor vehicle according to claim 5, wherein the supporting structure comprises extruded supports and a second part is a connecting piece that connects at least two of the extruded supports.

8. The motor vehicle according to claim 1, wherein the second set of fastenings comprises:
an elastically deflectable locking hook; and
an edge on which the elastically deflectable locking hook is configured to act in the stop position.

9. The motor vehicle according to claim 8, wherein the second set of fastenings is disposed on a body.

10. The motor vehicle according to claim 9, wherein a longitudinal member of the body is terminated at a front end by a flange and the second set of fastenings is disposed on the flange.

11. The motor vehicle according to claim 1, wherein the front module comprises:
a radiator assembly; and
a radiator frame extending around the radiator assembly.

12. The motor vehicle according to claim 11, wherein the radiator frame is formed at least in part by a plastic-sheathed sheet.

13. The motor vehicle according to claim 11, wherein the front module further comprises a bumper cross member.

14. The motor vehicle according to claim 11, wherein a width of the radiator frame decreases from a bottom to a top.

15. A method for assembling a motor vehicle, comprising:
fitting a first fastening into a second fastening of a chassis module and a front module of the motor vehicle in a preliminary position;
bringing the chassis module and the front module together with a body as far as a stop position of the chassis module on the body;
pivoting the front module about an axis defined by the first fastening that is fitted into a final position; and
fastening the front module on the chassis module or the body by means of second fastening means.

16. The method according to claim 15, further comprising fitting a hinge bolt and a fork by a lowering movement of the front module relative to the chassis module.

17. The method according to claim 15, further comprising:
fabricating a supporting structure;
a least partially fabricating a part of the supporting structure a molding method; and
molding the first fastening in one part with the part of the supporting structure.

18. The method according to claim 17, further comprising:
extruding supports; and
connecting at least two supports with a connecting piece.

19. The method according to claim 18, further comprising disposing the second fasten on the body.

20. The method according to claim 19, further comprising:
terminating a longitudinal member of the body at a front end by a flange; and
disposing the second fastening on the flange.
